(19) United States
(12) Patent Application Publication
(10) Pub. No.: US 2007/0118253 A1
(43) Pub. Date: May 24, 2007

(54) Distributed and adaptive data acquisition system and method

(75) Inventor: Steven Edward Dahler, Ballston Spa, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/282,695

(22) Filed: Nov. 21, 2005

(51) Int. Cl. G05D 1/00

(52) U.S. Cl. 701/1

(57) ABSTRACT

A method for establishing communications between a distributed data acquisition system and a plurality of sensors and a controller, wherein the data acquisition system comprises at least one micro-computer, the method includes: searching for sensors assigned to a micro-computer in the data acquisition system; requesting the assigned sensors to send identifier information to the micro-computer; using the identifier information and for each assigned sensor, selecting a sensor communications protocol from a library in the micro-computer corresponding to the assigned sensor, and generating a work list of the selected communications protocols to be used in communicating with the sensors assigned to the micro-computer.

### BACKGROUND OF THE INVENTION

The present invention relates to systems for acquiring sensor data from a variety of sensors and, in particular, establishing proper communications protocols with such sensors.

Complex systems, such as industrial gas turbines, are typically monitored by a variety of sensors. The sensors may monitor temperature, pressures, gas and liquid flows, rotational speed, humidity and other conditions relevant to the operation of the system. The sensors send data indicating the condition that they are each monitoring. Each sensor is configured to use a signaling protocol for communicating data. The signaling protocols may differ from sensor to sensor. As sensors are upgraded or replaced, the signaling protocol of the upgraded or new sensor may differ from the existing sensor.

The sensor data is communicated to controllers for the system. The controllers use the sensor data to, for example, monitor the system, generate control commands determine and report on conditions of the systems. In one example, the system is an industrial gas turbine and the controller is a computer that monitors sensors coupled to the turbine and generates commands, such as fuel flow commands.

To collect data from sensors requires a communication protocol to be established between the sensor and the controller. Typically, each sensor has a specific communications protocol and these protocols may vary from one sensor type or manufacturer to another. The variety of different sensor communications protocols and the likelihood that these protocols change as sensors are replaced or added to a system, presents a difficulty to controllers that have to communicate with the sensors. Controllers may not have the communications protocols for a new sensor. In the past, human operators have had to load communication protocols into the memory of controllers when adding a new sensor to a system. There is a long felt need for a solution that establishes communications with sensors so that sensor data can be provided to a controller, and that adapts to new sensors.

### BRIEF DESCRIPTION OF THE INVENTION

A modular, distributed data acquisition system has been developed to collect sensor data for a central controller. The data acquisition system recognizes sensors and adapts to the data transfer protocol of the various attached sensors.

A method has been developed for establishing communications between a distributed data acquisition system and a plurality of sensors and a controller, wherein the data acquisition system comprises at least one micro-computer, the method comprising: searching for sensors assigned to a micro-computer in the data acquisition system; requesting the assigned sensors to send identifier information to the micro-computer; using the identifier information and for each assigned sensor, selecting a sensor communications protocol from a library in the micro-computer corresponding to the assigned sensor, and generating a work list of the selected communications protocols to be used in communicating with the sensors assigned to the micro-computer.

In an alternative embodiment,-the method is for establishing communications between a distributed data acquisition system and a plurality of sensors monitoring a gas turbine and a controller for the gas turbine, wherein the data acquisition system comprises at least one micro-computer, the method comprising: searching for sensors assigned to a micro-computer in the data acquisition system, wherein each sensor is monitoring a condition of the gas turbine; requesting the assigned sensors to send identifier information to the micro-computer; using the identifier information and for each assigned sensor, selecting a sensor communications protocol from a library in the micro-computer corresponding to the assigned sensor, and generating a work list of the selected communications protocols to be used in communicating with the sensors assigned to the micro-computer.

A distributed data acquisition system has been developed for providing sensor data to a controller and acquiring sensor data from a plurality of sensors, the data acquisition system comprising: a computer system including a processor, a memory accessible by the processor, a sensor communication link for connecting to at least one communication path to a plurality of sensors and a controller communication link for connecting to a communication path to the controller; a library of sensor communication protocols stored in the memory, and an interrogator software program stored in the memory and executed by the processor to poll sensors assigned to the computer system, identify each of the assigned sensors and select an appropriate communication protocol from the library for each sensor.

### BRIEF DESCRIPTION OF THE DRAWINGS

FIG. 1 is a schematic diagram of a gas turbine system having a controller and being monitored by sensors.

FIG. 2 is a schematic diagram of sensors for the system, a plurality of micro-computers for communicating with the sensors and a controller that communicates with the micro-computers.

FIG. 3 is a flow chart of a procedure to identify and select communication protocols for sensors.

### DETAILED DESCRIPTION OF THE INVENTION

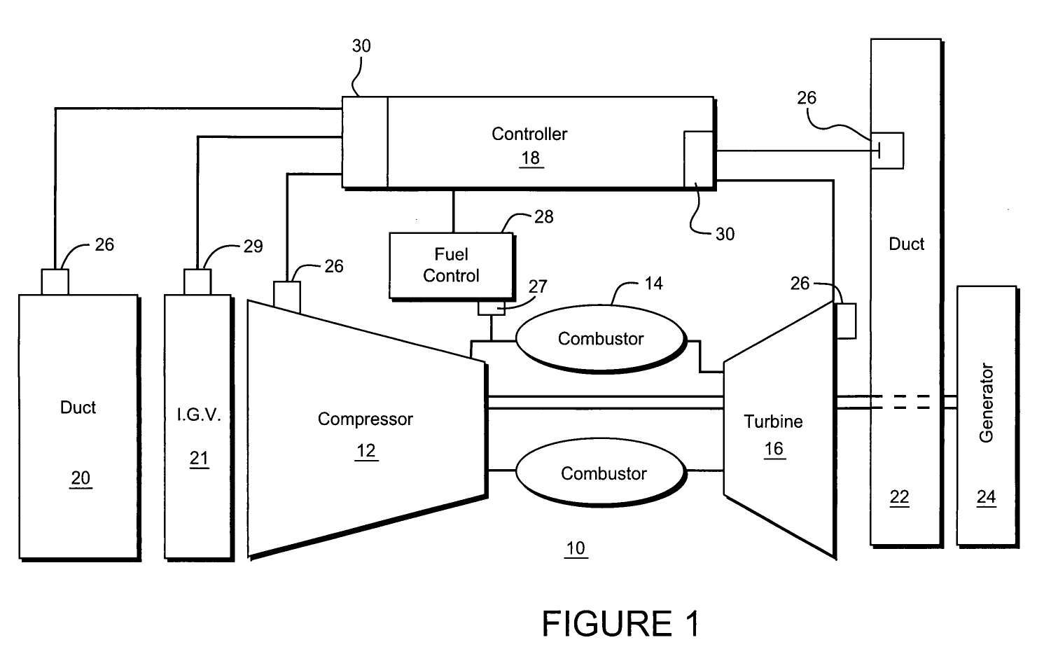

FIG. 1 depicts a gas turbine 10 having a compressor 12, combustor 14, turbine 16 drivingly coupled to the compressor, and a computer control system (controller) 18. An inlet duct 20 to the compressor feeds ambient air and possibly injected water to the compressor. The inlet duct may have ducts, filters, screens and sound absorbing devices that contribute to a pressure loss of ambient air flowing through the inlet 20 into inlet guide vanes 21 of the compressor. An exhaust duct 22 for the turbine directs combustion gases from the outlet of the turbine through, for example, emission control and sound absorbing devices. The exhaust duct 22 may include sound adsorbing materials and emission control devices that apply a backpressure to the turbine. The amount of inlet pressure loss and back pressure may vary over time due to the addition of components to the ducts 20, 22, and to dust and dirt clogging the inlet and exhaust ducts. The turbine may drive a generator 24 that produces electrical power. The inlet loss to the compressor and the turbine exhaust pressure loss tend to be a function of corrected flow through the gas turbine.

The operation of the gas turbine may be monitored by several sensors 26 detecting various observable conditions of the turbine, generator and ambient environment. In many instances two or three redundant sensors measure the same measured condition. For example, groups of three redundant temperature sensors 26 may monitor ambient temperature surrounding the gas turbine, compressor discharge temperature, turbine exhaust gas temperature, and other temperature measurements of the gas stream through the gas turbine. Similarly, groups of three redundant pressure sensors 26 may monitor ambient pressure, and static and dynamic pressure levels at the compressor inlet and outlet, turbine exhaust, at other locations in the gas stream through the gas turbine. Groups of three redundant humidity sensors 26, e.g., wet and dry bulb thermometers, measure ambient humidity in the inlet duct of the compressor. Groups of three redundant sensors 26 may also comprise flow sensors, speed sensors, flame detector sensors, valve position sensors, guide vane angle sensors, or the like that sense various parameters pertinent to the operation of gas turbine 10.

A modular, distributed data acquisition system 30 has been developed to collect sensor data for a central controller. The data acquisition system 30 recognizes sensors and adapts to the communications protocol (e.g., data transfer protocols) of the various attached sensors. The data acquisition system 30 may be logically included with the controller 18, but may be a physically separable component of the controller that is either physically connectable to the controller, or connected to the controller by a wired or wireless communication path.

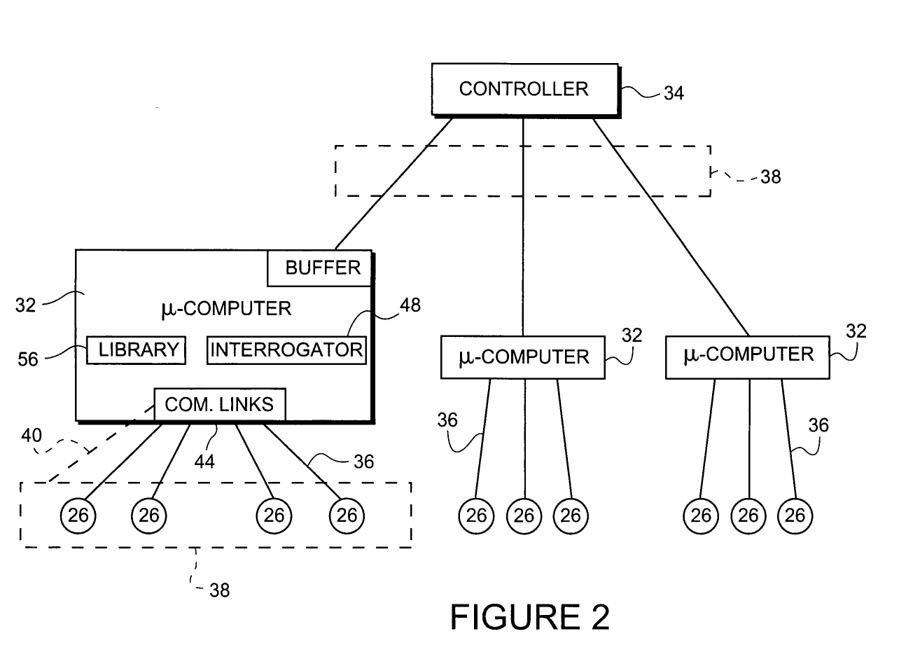

FIG. 2 is a schematic diagram of sensors 26 for the gas turbine, a plurality of micro-computers 32 that comprise data acquisition system 30 and the controller 34 that communicates with the micro-computers 32. The controller 34 is similar to controller 18, except that for purposes of this discussion controller 34 and data acquisition system 30 are treated as a separate components. In contrast, controller 18 include the data acquisition system.

The sensors 26 monitor the gas turbine. As is described above, there is a wide variety of sensors monitoring different turbine conditions. The sensors may vary by sensor type, e.g., temperature, pressure and flow rate, sensor model and manufacturer, and sensor software. Further, the sensors may include an interface electronic board that collects data directly from the sensors and establishes a communications link 36, e.g., a wired or wireless link, with the micro-computers 32.

The sensors 26 may be arranged in a data communications network, e.g., local area network (LAN). The sensor LAN 38 may be exclusively a sensor LAN or may be a general purpose LAN handling data communications for sensors and other computer systems. The LAN and its communication path are shown by dotted lines to indicate that they are an alternative to the direct communication path 36 between the sensors and micro-computer 32. The LAN provides a convenient communication path 40 between the sensors 26. The LAN communications protocol may be a conventional protocol, such as a Ethernet protocol (IEEE 802.3 which is commonly known as the CSMA/CD protocol).

The micro-computers 32 may be modular units that provide an interface between the sensors 26 and controller 34. The micro-computers 32 may be included on the LAN 38 that provides a communication path to the sensors and to the controller. Alternatively, the micro-computers may have direct communication paths to the sensors and controller. The micro-computers 32 may be a personal computer (PC), an embedded computer associated with the controller or a sensor interface, or a program logic controller (PLC) device.

The micro-computers 32 function as data collection nodes for the controller 34, in turn, which functions as a host-computer for the micro-computers. The micro-computers may include a processor, an associated digital memory and a communications link, such as ports, an networking electronic card and wireless devices. Sensor data is temporarily stored by a buffer 42 in each of the micro-computers. The sensor data stored in the buffer is communicated to the controller at the request of the controller to the micro-computer, in accordance with a predetermined schedule for transferring data or when the micro-computer determines that the buffered data should be transferred. The schedule and protocol for transferring data from the micro-computers to the controller are determined by the controller 34 and/or by the micro-computers.

A communication link 44 in each micro-computer provides a portal for sensor communications. The communication link may comprise one or more physical connectors for an Ethernet cable or portal connector for the sensors. The communication link also includes a software component that includes a work list having the communications protocol for the various sensors communicating with the micro-controller. These sensor communication protocols are typically software provided by the sensor manufacturer. The communication protocols are used by the micro-controller to communicate with the sensor, collect data generated by the sensor, interrogate the sensor, and to test and determine the condition of the sensor. The communication protocol for one sensor connected to the micro-computer may be different than the communication protocol for another sensor connected to the micro-computer. These communication protocols are loaded into the work list of the communications link by the micro-computer to setup a communication path to each of the sensors.

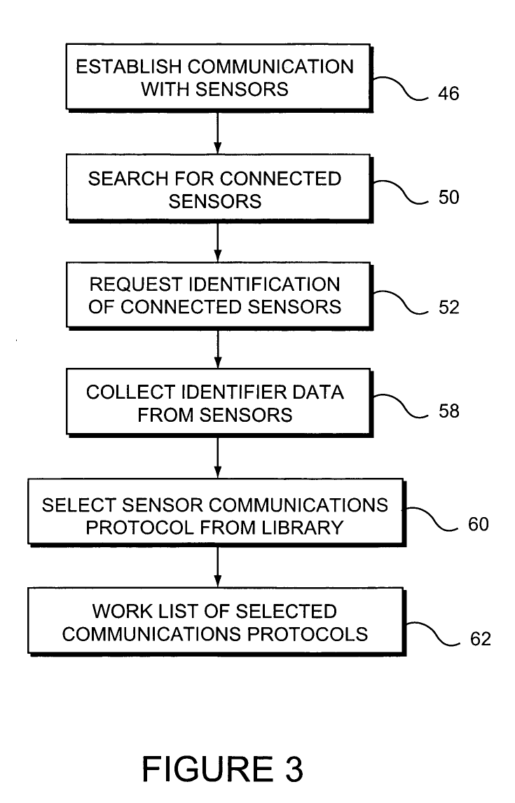

FIG. 3 is a flow chart of an exemplary setup procedure for a micro-computer that establishes communication, step 46, with each of the sensors assigned to the micro-computer. To establish communications, an interrogator program 48 initially searches, step 50, for sensors logically assigned and/or connected to the micro-computer. For sensors directly connected to the micro-controller, the interrogator determines whether sensors are physically connected to the communication link 44 or are in wireless communication with the micro-computer (and not in wireless communication and assigned to another micro-computer). For sensors connected to the micro-computer via the LAN, the interrogator may poll the LAN addresses of sensors assigned to the micro-computer (using sensor addresses provided by the controller 34), or send requests for response commands to sensors in the LAN requesting a response from sensors assigned to the micro-computer or from sensors that are not assigned to any micro-computer.

The interrogator 48 of the micro-computer sends to each sensor a command requesting the sensor to respond with information identifying the sensor, in step 52. The issuance of the sensor identification command (step 52) may be preformed at the same time as when the micro-computer polls the sensors to determine which sensors are responding, or after the micro-computer has determine which sensors are assigned to it.

The request for identification command is command to which a sensor responds with information indicating the type, make and manufacturer (or other identifying information) of the sensor. There is no request for identification command is not common to all sensors, although there may be some standard request for sensor identification commands to which a variety of sensors will respond with their identification information. Because not all sensors respond to the same request for identification command, the interrogator issues a series of different request for identification commands.

The interrogator accesses a digital library 56 in the micro-computer that includes request for identification commands for a variety of sensors. The interrogator may request from the library the request for identification commands corresponding to the sensors assigned to the micro-computer and issue those commands serially from the communication link 44. If the interrogator has not determine which sensors are assigned to micro-computer, does not know which requests for information commands to issue for all assigned sensors or is aware of an assigned sensor that is not responding to a prior request for identification command, the interrogator may request all request for identification commands from the library and send all of the commands to all sensors or only to the non-responding sensor(s).

The sensors each respond with their identifying information to the request for information command appropriate to that sensor. The micro-computer collects the sensor identifier data sent by each of the sensors, in step 58. The identifier data for each sensor is associated with information defining the sensor signal path to the micro-controller. The signal path may be the sensor address on the LAN or the port in the communication link 44 to which the sensor is connected. The sensor identifier information and the signal path provides the micro-computer with sufficient information to establish a communication link 36, 40 with the sensor.

The setup the communication link, the micro-computer selects the appropriate communication protocol for the sensor from the library in step 60. The library 56 stores a collection of sensor communication protocols that are accessed using the sensor identifier information. The library may include a look-up table that maps sensor communication protocols to one or more types of sensor identification information. The interrogator uses a sensor identifier and the look-up table to select an appropriate communication protocol for the corresponding sensor.

If the library does not have a suitable communication protocol, the micro-computer may search for a suitable protocol by accessing an Internet website for the sensor manufacturer. In addition, the micro-computer may periodically poll the websites of sensor manufacturers to download sensor communication protocols to the library 56.

The interrogator selects the sensor communication protocols for each of the sensors assigned to the micro-computer. A work list of the selected communication protocols is prepared by the micro-computer in step 62. The work list is used by the communications link 44 to communicate with the sensors.

The communications protocols are used by the micro-computer to collect data from the sensors. The collected data is transferred to the buffer 42 for subsequent transfer to the controller 34. The micro-computers also use the communication protocols to determine the status of sensors, test sensors and otherwise communicate with the sensors.

If the communication link 44 determines that a sensor is no longer responding, the micro-computer may have the interrogator 48 send a request for identification command to the sensor and, using the sensor identifier information received in response, look-up in the library the communications protocol for the sensor. If the library has an updated communications protocol for the sensor, the updated protocol is assigned to the work list and the prior protocol in the work list for the sensor is deleted. If the library does not have an updated protocol or the sensor does not respond to the updated protocol, the micro-computer issues a sensor failure notice to the controller 34.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for establishing communications between a distributed data acquisition system and a plurality of sensors and a controller, wherein the data acquisition system comprises at least one micro-computer, the method comprising:
searching for sensors assigned to a micro-computer in the data acquisition system;
requesting the assigned sensors to send identifier information to the micro-computer;
using the identifier information and for each assigned sensor, selecting a sensor communications protocol from a library in the micro-computer corresponding to the assigned sensor, and
generating a work list of the selected communications protocols to be used in communicating with the sensors assigned to the micro-computer.

2. The method of claim 1 wherein the steps of searching requesting, selecting and generating a work list are performed for a plurality of micro-computers and each micro-computer has a unique sent of assigned sensors.

3. The method of claim 1 wherein the search for sensors is conduct before and as a separate step of requesting sensor identifier information.

4. The method of claim 1 wherein the search for sensors is conduct in combination with the step of requesting sensor identifier information.

5. The method of claim 1 wherein a look-up table is used to correlate the sensor identifier information with the selected sensor communications protocol to select the protocol.

6. The method of claim 1 wherein the request for sensor identifier information includes sending a sensor identification command for each of the assigned sensors.

7. The method of claim 1 wherein the request for sensor identifier information includes sending a sensor identification command for all sensors for which the library has a sensor identification command.

8. The method of claim 1 further comprising using the work list to select the sensor communication protocol for an assigned sensor for the collection of sensor data.

9. A method for establishing communications between a distributed data acquisition system and a plurality of sensors monitoring a gas turbine and a controller for the gas turbine, wherein the data acquisition system comprises at least one micro-computer, the method comprising:
searching for sensors assigned to a micro-computer in the data acquisition system, wherein each sensor is monitoring a condition of the gas turbine;
requesting the assigned sensors to send identifier information to the micro-computer;
using the identifier information and for each assigned sensor, selecting a sensor communications protocol from a library in the micro-computer corresponding to the assigned sensor, and
generating a work list of the selected communications protocols to be used in communicating with the sensors assigned to the micro-computer.

10. The method of claim 9 wherein the steps of searching requesting, selecting and generating a work list are performed for a plurality of micro-computers and each micro-computer has a unique sent of assigned sensors.

11. The method of claim 9 wherein the search for sensors is conduct before and as a separate step of requesting sensor identifier information.

12. The method of claim 9 wherein the search for sensors is conduct in combination with the step of requesting sensor identifier information.

13. The method of claim 9 wherein a look-up table is used to correlate the sensor identifier information with the selected sensor communications protocol to select the protocol.

14. The method of claim 9 wherein the request for sensor identifier information includes sending a sensor identification command for each of the assigned sensors.

15. The method of claim 9 wherein the request for sensor identifier information includes sending a sensor identification command for all sensors for which the library has a sensor identification command.

16. The method of claim 9 further comprising using the work list to select the sensor communication protocol for an assigned sensor for the collection of sensor data.

17. A distributed data acquisition system for providing sensor data to a controller and acquiring sensor data from a plurality of sensors, the data acquisition system comprising:
a computer system including a processor, a memory accessible by the processor, a sensor communication link for connecting to at least one communication path to a plurality of sensors and a controller communication link for connecting to a communication path to the controller;
a library of sensor communication protocols stored in the memory, and
an interrogator software program stored in the memory and executed by the processor to poll sensors assigned to the computer system, identify each of the assigned sensors and select an appropriate communication protocol from the library for each sensor.

18. The distributed data acquisition system of claim 17 wherein the controller is a controller for a gas turbine, and the sensors monitor conditions of the gas turbine.

19. The distributed data acquisition system of claim 17 wherein the sensor comprise pressure sensors, temperature sensors and flow sensors.

20. The distributed data acquisition system of claim 17 wherein the computer system is a plurality of micro-computers each connectable to the controller.
